(19) United States
(12) Patent Application Publication
(10) Pub. No.: US 2006/0178932 A1
(43) Pub. Date: Aug. 10, 2006

(54) Method and distribution system for location based wireless presentation of electronic coupons

(76) Inventor: Brook W. Lang, Issaquah, WA (US)

Correspondence Address: DEAN A. CRAINE, STE. 140, 400 - 112TH AVENUE NE, BELLEVUE, WA, 98004, US

(21) Appl. No.: 11/053,095

(22) Filed: Feb. 7, 2005

(51) Int. Cl. G06Q 30/00

(52) U.S. Cl. 705/14

(57) ABSTRACT

A method and system for distributing electronic coupons offered by businesses via the wireless devices operated by potential customers in a region. The invention includes a wireless communication device and a central server capable of communicating via a wireless communication network The central server is connected to a search engine, a business database containing the names and locations of businesses located in the region offering discounted coupons for goods and services to its potential customers. Connected to the central server is a discount coupon database and a map database that contains coupon information, a graphic file of the coupon, and the businesses location information. When the potential customer desires a discount coupon for a particular service or goods in the region, the potential customer contacts the central server, which instructs the search engine to conduct a search based on the criteria submitted by the potential customer. The search engine produces a list of businesses currently offering discount coupons that is then transmitted to the potential customer.

### BACKGROUND OF THE INVENTION

1. Field of the Invention

The invention disclosed herein pertains to methods for businesses selling services or products that advertise and distribute coupons to its customers and, more particularly, to such methods that distributed advertisements over wireless networks.

2. Description of the Related Art

Businesses often distribute printed discount coupons to potential customers in local area newspapers and magazines. Businesses also hire companies to prepare and mail printed discount coupons to potential customers in designated zip code areas. In order to obtain the discount, most businesses require that the customer present the coupon when the service or goods is ordered or purchased.

Businesses have been advertising over the world wide web (www) for over a decade. More recently, businesses have began offering on their websites discount coupons that potential customers may download into their computers, print locally, and then physically presented or mailed to the business when the service or goods are ordered or purchased.

Unfortunately, both coupon distribute schemes require that coupons be cutout from another publication or printed by a printer, and manually completed and presented before they can be redeemed. If the customer does not have copies of the coupon or the publication containing the coupon, or a printer connected to a wide area network (i.e. Internet) connected computer, the customer cannot take advantage of the coupon offer.

What is needed is a coupon distribution system for mobile customers who use a wireless communication device capable of connecting to a wireless communication network that does not require the presentation of a printed coupon.

### SUMMARY OF THE INVENTION

It is an object of the present invention to provide a business discount coupon distribution and presentation method for a wireless communication network.

It is also an object of the present invention to provide such a method that can be easily used in an existing wireless communication network.

It is another object of the present invention to provide such a method that enables potential customers to easily determine which businesses are currently offering discount coupons in a selected region and then delivers the coupon to a wireless device capable of connecting to the wireless communication network.

It is a further object of the present invention to provide such a method that uses an electronic coupon in place of a paper coupon that can be verified and easily presented to a business representative when the offer on the coupon is accepted.

These and other objects are met by the method and system for distributing and visually presenting electronic coupons offered by businesses to its customers over a wireless communication network. The invention includes the use of wireless communication devices used by the potential customers of a business that are able to connect to an existing wireless communication network operated in the designated region around the business. Each wireless device includes a display capable of presenting an electronic coupon images or icons downloaded to the wireless device over the wireless communication network.

The wireless communication network is directly or indirectly connected via a wide area network, such as the world wide web (www), to a central server operated by a system administrator. The central server is connected to a search engine and a business database containing the names, addresses, telephone numbers, and current discount coupon information of various businesses located in a designated region and signed up for the system. The central server includes a location database that can either receive manually inputted location information or GPS location information from the wireless device. Alternatively, the central server may be connected to the wireless communication network carrier that enables the central server to determine or receive the potential customer's' location reference point from the carrier.

During use, the potential customer contacts the central server and selects from a main menu page a general category of goods or services that the potential customer is interested in purchasing or ordering immediately or in the near future. When the potential customer selects one of the general categories, one or more linked sub-menus containing sub-categories information may be presented to the potential customer that more clearly defines or identifies the desired goods or services. When the proper sub-category is identified, a request is then submitted to the central server. The central server then requests a search be preformed by the search engine using the criteria submitted by the potential customer.

Accompanying each request is the potential customer's location reference point that the search engine also uses as a search criteria for identifying nearby businesses. The potential customer's location reference point may be the potential customer's current address, zip code, or cross street location at the time of the request or the address, zip code or cross-street location of the potential customer at a future date or time. The system may be adjusted so that the potential customer's location reference point may be automatically determined by the system itself or manually inputted by the potential customer when the request is submitted to the central server.

In order to perform the search, the central server or search engine must know the size of area to search, called the search radius. The central point of the search radius is known as the potential customer's location reference point. In the preferred embodiment, the system provides a secondary menu page to the potential customer enabling the potential customer to indicate the desired search radius (e.g. 1 mile, 5 miles, 20 miles, etc). Optionally, the system could be setup to always use a default search radius or to use a default radius whenever a new search radius is not selected.

In response to a request, the central server identifies the potential customer's location reference point, the selected goods and services criteria, the search radius, and then instructs the search engine to conduct a search of the applicable databases to create a search result. In the preferred embodiment, the search result is a list of business names that meet the search criteria. The order of the businesses in the list may be modified or adjusted depending on the business model followed by the system operator. Once the search results are produced, it is then transmitted to the potential customer's wireless display or desktop computer monitor. The search results may be presented in a map format showing the relative locations of the business found in the search. Accompanying each business name entry may be an optional the coupon's parameter information page that more fully informs the potential customer of the coupon offer. The coupon's parameter information may include the percent of discount, the expiration date and time, and statements regarding other terms, conditions or limitations that may apply or limit the use of the coupon. Also, associated with each business listing may be an optional business information page which may include the business address, telephone number and a mileage or distance indicator from the potential customer's current location reference point. Further, each business list could include additional travel information such as a current ETA to the business from the location reference point based on current and or future traffic conditions. Driving instructions to the business from the location reference point could also be provided. An auto telephone dialing or auto electronically ordering option or page for goods and services features may be provided with each business listing. Further, an optional map may be generated and transmitted to the potential customer or resident on the wireless device showing the relative locations of the selected businesses found in the search.

When the information is transmitted to the potential customer, the potential customer then reviews the list and, if desired, selects one of the businesses. In the preferred embodiment, the coupon parameter information page for the coupon is then transmitted and presented to the potential customer. The potential customers then reviews the full terms of the coupon and, if acceptable, presses an ‘accepted’ response. After the coupon offer has been accepted, the central server transmits immediately or at a later designated time, the business' electronic coupon to the potential customer's device.

In the preferred embodiment, the electronic coupon is delivered to the wireless device's memory in an ‘inactive’ state and must be ‘activated’ prior to using it. Each electronic coupon is date and time stamped and has an expiration period associated therewith. Simultaneously, the central server may record the potential customer's request, a unique coupon serial number assigned to the coupon and to each potential customer or his or her device, and the date of transmission to control and record the number of coupons delivered to the same device or device owner. These features allow the business to, if desired, limit the coupon to only one time use by the requesting and to a designated time period. For example, the parameters of the coupon may be limited by the business so that the coupon is only valid for 4 hours time periods, anytime during the current month.

Using this system, after the potential customer has downloaded the ‘inactive’ coupon to the devices' memory, it is ‘activated’ using a “display, review and use coupons” feature of the application. Only when the potential customer retrieves the coupon in the application's “display, review and use coupons” feature is the businesses designated time period allowed to be marked and started and then displayed as part of the mobile electronic visual coupon with the time period and expiration time and date as part of the visual for the business to see when validating that the coupon is valid and granting the offer to the potential customer. Additionally the potential customer could specify the start time and date of 4 hours for marking and display of the time and expiration time and date of the mobile electronic visual coupon.

When the potential customer visits the business to purchase or order the services or goods, the ‘activated’ electronic coupon stored in the device's memory is then presented on the device's display and shown to the business representative. The business representative is able to quick review the electronic coupon and, if necessary, record the coupon's serial number.

The above described method and system allows mobile potential customers to quickly and easily identify businesses offering discount coupons in the designated region. Because electronic coupons are distributed rather than printed coupons, the production, distribution and disposal costs for the coupons are substantially lower than the printed discount coupon distribution systems used in the prior art. Also, because each electronic coupon can be day and time stamped, the process of identifying a valid coupon is relatively easy and less susceptible to fraud and abuse for businesses. Also, each business is able to easily monitor the distribution of coupons, the number of potential customers that accept the offer, and, if necessary, adjust the coupon offer for changing business conditions.

### DESCRIPTION OF THE DRAWINGS

FIG. 1 is an illustration of a discount coupon distribution and presentation system for a wireless communication network.

FIG. 2 is a front plan view of a wireless telephone with the system's main menu presented on the device's display.

FIG. 3 is a front plan view of a wireless telephone with a location determination menu presented on the device's display.

FIG. 4 is a front plan view of a wireless telephone with a general category menu presented on the device's display.

FIG. 5 is a front plan view of a wireless telephone with a vicinity location menu presented on the device's display.

FIG. 6 is a front plan view of a wireless telephone with a type of food sub-menu presented on the device's display.

FIG. 7 is a front plan view of a wireless telephone with a map on the region searched presented on the device's display that presents a list of businesses offering coupons in the region.

FIG. 8 is a front plan view of a wireless telephone presenting in text form a list of businesses offering coupon in the region and presented on the device's display.

FIG. 9 is a front plan view of a wireless telephone presenting a secondary information menu page of a business listed on the list shown in FIG. 8.

FIG. 10 is a front plan view of a wireless telephone presenting a confirmation that the coupon has been successfully downloaded and stored on the wireless telephone and an optional menu page from the system to provide turn-by-turn driving instructions or an auto/dial feature to the business.

FIG. 11 is a front plan view of a wireless telephone presenting ETA information to the customer based on current traffic conditions and an option menu to start turn-by-turn driving instructions.

FIG. 12 is a front plan view of a wireless telephone presenting turn-by-turn driving instructions to the customer.

FIG. 13 is a front plan view of a wireless telephone presenting an optional search menu enabling the customer to search for new coupons and discounts or to display previously downloaded coupons and discounts.

FIG. 14 is a front plan view of the wireless telephone showing a discount coupon presented on the device's display that has fully been activated with current expiration time and date stamp.

### DESCRIPTION OF THE PREFERRED EMBODIMENT(S)

There is shown and described herein a system 10 allows mobile potential customers 11 and 11′ to quickly and easily identify businesses 13 offering discount coupons 20 in the selected region. 16. The system 10 uses electronic coupons 20 that are produced and distributed to the customer's wireless communication devices 30. The coupons 20 are immediately or selectively transmitted from a central server 42 to the potential customer over a wireless communication network 25 used by the wireless communication device 30. When the electronic coupon 20 is received by the customer 11 it is temporarily stored in memory in an ‘inactive’ or ‘active’ status on the wireless communication device 30. When activated on the wireless device 30 the electronic coupon 20 is then presented to the business 13 and redeemed. An important feature of the system 10 is that the electronic coupon 20 can be quickly modified by the business representative or the central server operator, and date and time stamped. The system also enables the business representative or central server operator to monitor the number of requests and downloads thereby enabling businesses greater feedback, flexibility and security over existing paper coupon distribution systems.

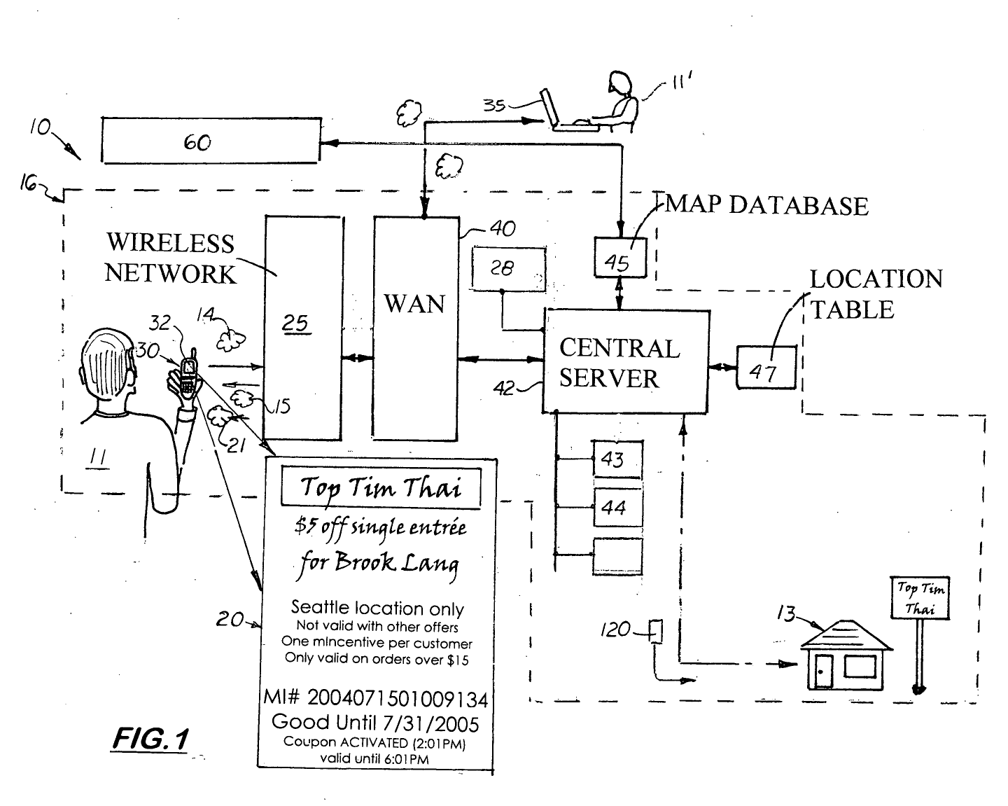

Referring to FIG. 1, a potential customer 11, 11′ is shown accessing the system 10 via a handheld remote wireless communication device 30 or by a stationary laptop/desktop computer 35 via a WAN, respectively. The wireless communication device 30 must be able to connect to an existing wireless communication network 25 operated in the region 16. As shown in Figs., each wireless communication device 30 includes a display 32 and a plurality of input buttons or keys (not shown) that enable the user to make selections on the display or to type in selections. The display 32 must be able to present graphic files or icons of the electronic coupon 20 downloaded to the wireless communication device 30.

In the preferred embodiment, the wireless communication network 25 is connected to a wide area network 40, such as the world wide web (WWW). The central server 42 must be able to connect to the wide area network 40 and must be able to communicate with either the wireless communication device 30 or the laptop/desktop computer 35. Compatible network communication software must be installed in the wireless communication device 30, the desktop 35 and the central server 42. It should be understood that the wide area network 40 could be eliminated so that the central server 42 is directly connected to the wireless communication network 25 or directly connected to a WAN or LAN to communicate with the laptop/desktop computer 35.

The central server 42 is connected to a search engine 28 capable of searching a business database 43 containing the names, addresses, telephone numbers and possibly other information and images of various businesses in the region 16. The central server 42 is also connected to a business coupon database 44 containing the discount coupon information for businesses in the business database 43. In the accompanying Figs, the business database 43 and the business coupon database 44 are described and shown as separate databases, but it should be understood that they could be combined and/or directly connected to the search engine 28. Also connected to the central server 42 are a map database 45, and a location table database 46. One purpose of the location table database 46 is to coordinate the business' addresses, latitude and longitude coordinates, and zip code information with the map database 45.

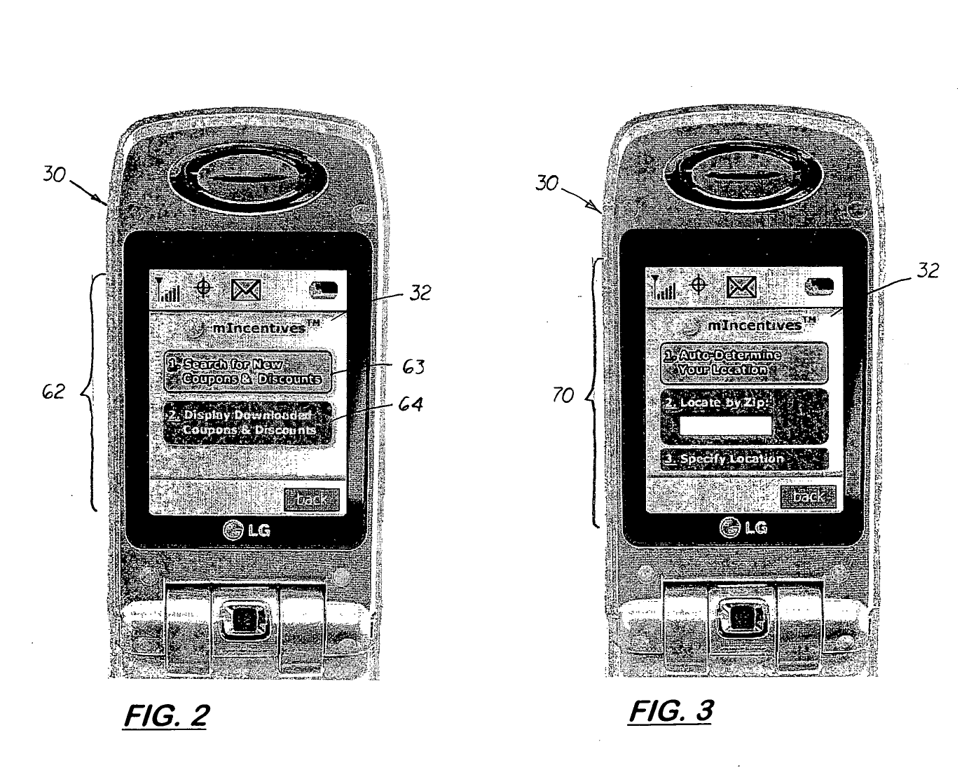

When a mobile potential customer 11 desires a discount electronic coupon 20 for a specific good or service from a local business 13, the potential customer 11 uses his or her wireless communication device 30 to submit a request 14 to the system's central server 42. The central server 42 then transmits a series of sub-menu pages generally denoted in FIG. 1 as 15, until a refined search may be conducted by the search engine. As shown in FIG. 2, the wireless communication device 30 may be cellular telephone with a touch pad display 32 and a plurality of touch keys (not shown). Typically, the request 14 is submitted on an introduction menu page 62 presented on the display 32 as shown in FIG. 2. The introduction menu page 62 gives the potential customer 11 the options of searching for new coupons (designated 63) or to display the previously downloaded coupons and displays.

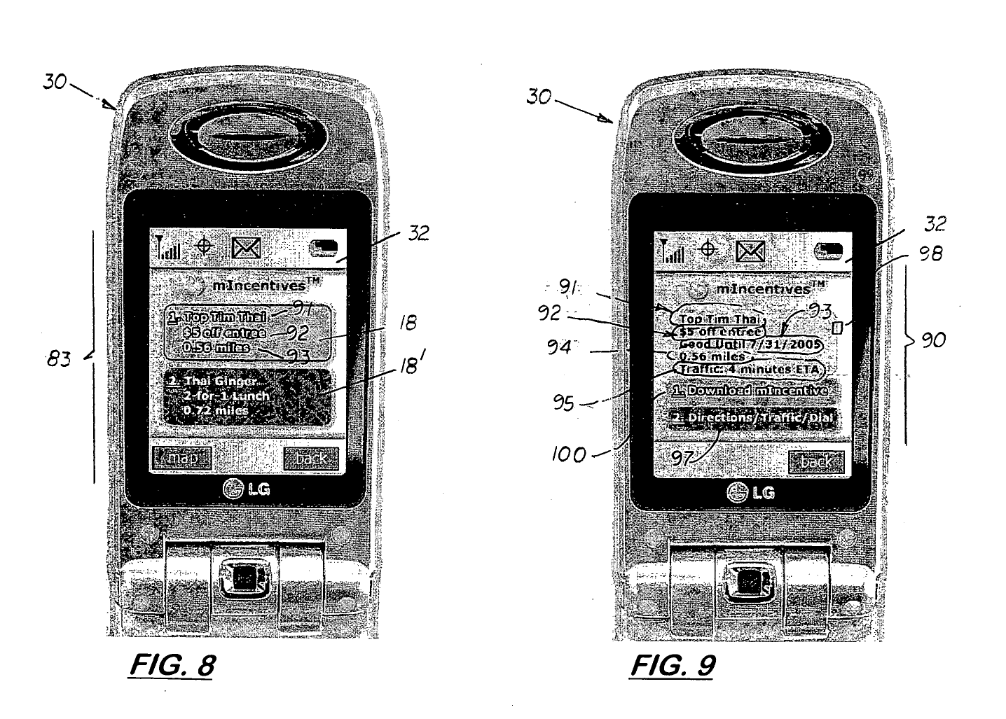

The request 14 is transmitted to the central server 42 via the wireless communication network 25 and the wide area network 40. A search is performed by the search engine 28 that uses the specific criteria manually selected by the potential customer 11 or automatically determined by the system 11 to produce a text list or map of business offering discount coupons and discounts shown in FIGS. 8 and 7, respectively.

When a request 14 is received, the potential customer's location reference point must be determined which is used by the search engine 28 as a reference location for the search radius. The system 10 is designed to use one of three possible methods for determining the customer's current or future location—automatically detection using the customer's GPS location information, or cellular triangulation information; the inputted zip code; or the specify address or intersection information. Additionally, the central server 42 could receive the location information from the wireless carrier 60. FIG. 3 is an illustration of a reference location menu page 70 presented on the device's display 32 enabling the potential customer to select one of these three methods.

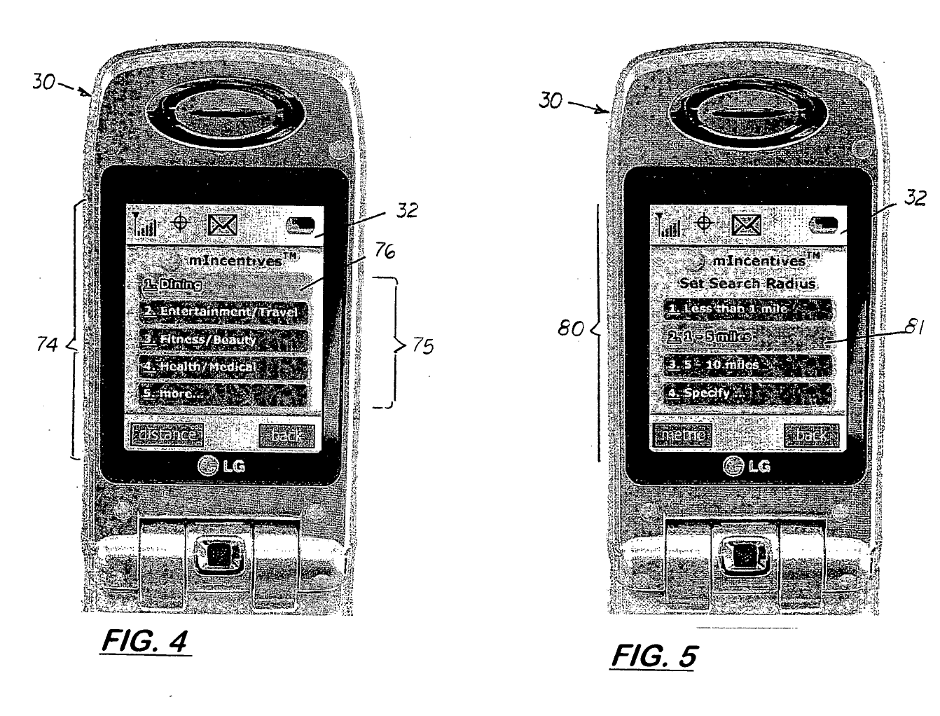

After the reference location point is established, the central server 42 then transmits a generally category menu page 74 to the display as shown in FIG. 4. The general category menu page 74 includes a general category list of the types of goods and services of businesses currently enrolled in the system 10. When a particular type of good or service is selected (i.e. Dining 76), a search radius menu page 80 is presented on the display 32 as shown in FIG. 5. On the search radius menu page 80, the potential customer informs the central server 42 the maximum distance he or she will travel from the reference location point. The search is thereby limited to businesses within the designated radius.

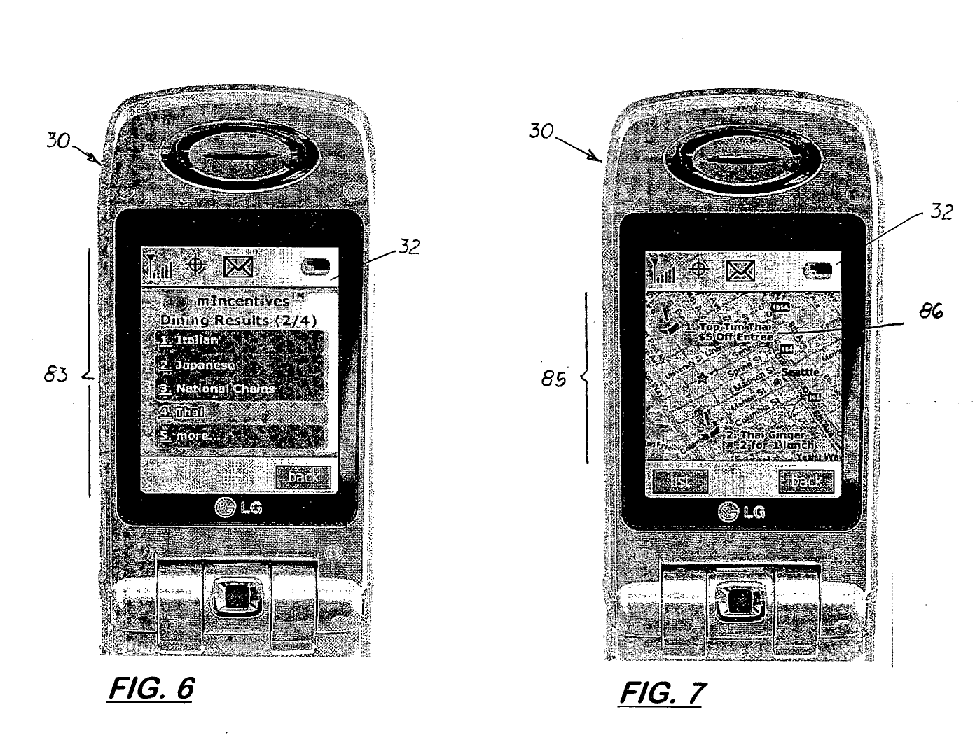

After a designated radius (i.e. 1-5 miles button 81) is made on the search radius menu page 80 and transmitted to the central server 42, the first sub-category menu page 83 is presented. The content of the sub-category menu page 83, as shown in FIG. 6, is designed to further define the selection on the general category menu page 74 shown in FIG. 4. Additional second and third sub-category menus (not shown) may branch from the first sub-category menu page 83 may be presented to the potential customer 11 to further identify and define the goods and services desired.

The sub-menu page 83 shown in FIG. 6 serves as the specific sub-category menu page for the goods and services. In addition to or as an alternative to presenting the information as a list, the search results could be displayed in a map 80 showing the business thereon. In order to prepare the map 80, the central server 42 uses both the business information database 43 and the map database 45. The map 80 may contain the names of the business along with general information 86 on the discount coupon. The map may also have already excited on the device 30 and just the business locations and information and or coupon information is downloaded to the device 30.

FIG. 8 shows a specific search results page 83 produced by the search engine showing two businesses entries 18, 18′ presented in a text format that meet the search criteria selected by the potential customer 11. In the preferred embodiment, the general information of the coupon offer and the name of the business 91 are displayed. As an optional feature, the distance 94 of the business from the location reference point is also displayed.

When a business entry 18 is selected from the menu page 83 in FIGS. 7 or 8, a more detailed discount information page 90 is displayed (see FIG. 9) that informs the customer of the terms of the coupon. More specifically, the information includes the name of the business 91, the amount of discount 92, the expiration date of the coupon 93, the distance 94 to the business from the reference location point. This is the menu page where the potential customer selects to download the coupon to the device's memory. In addition, the menu page 90 may include ETA information 95 based on current or anticipated traffic conditions. If the potential customer desires driving instructions 97, traffic condition information, or would like to telephone the business to make a reservation or place an order, addition selection buttons 98 maybe provided.

In FIG. 9, a ‘Download’ button 100 is shown on the menu page 90 that the potential customer 11 uses to select the coupon offer from the business entry 18 on the display 32. As stated above, in the preferred embodiment, a downloaded coupon 20 is a compressed graphic file 21 that must be ‘activated’ before it may be used. ‘Activation’ step may occur automatically when the coupon file 21 is downloaded from the central server 42 to the wireless device 30 or may occur later after the coupon file 21 is opened on the wireless device or when a separate activation button is pressed by the customer.

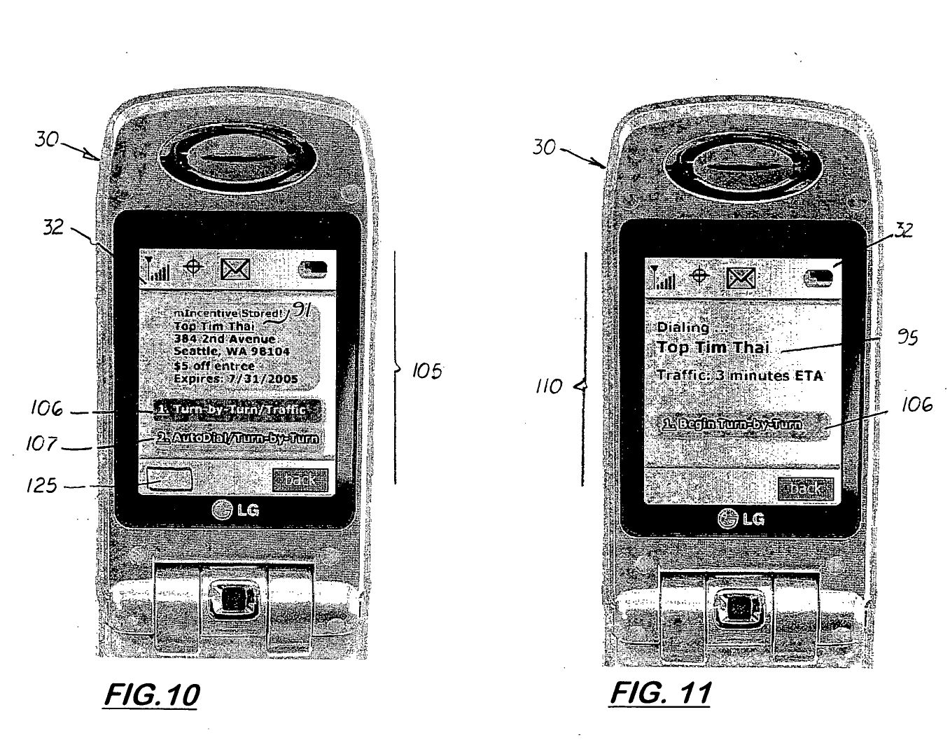

FIG. 10 is an illustration of the display 32 showing that a summary menu page 105 for the discount coupon 20 from the business 91 (i.e. Top Tim Thai) has been stored on the wireless device 30. The more detailed, coupon parameter information 23 is also shown on the menu page 105. In addition, turn-by-turn driving instructions button 106, current traffic auto dial button 104, and a traffic congestion information button may be presented.

FIG. 11 is an illustration of the auto dialing page 110 showing the wireless device 30 being used to automatically dial the business. In addition, the ETA information 95 may be presented along with a turn-by-turn instructions button 106.

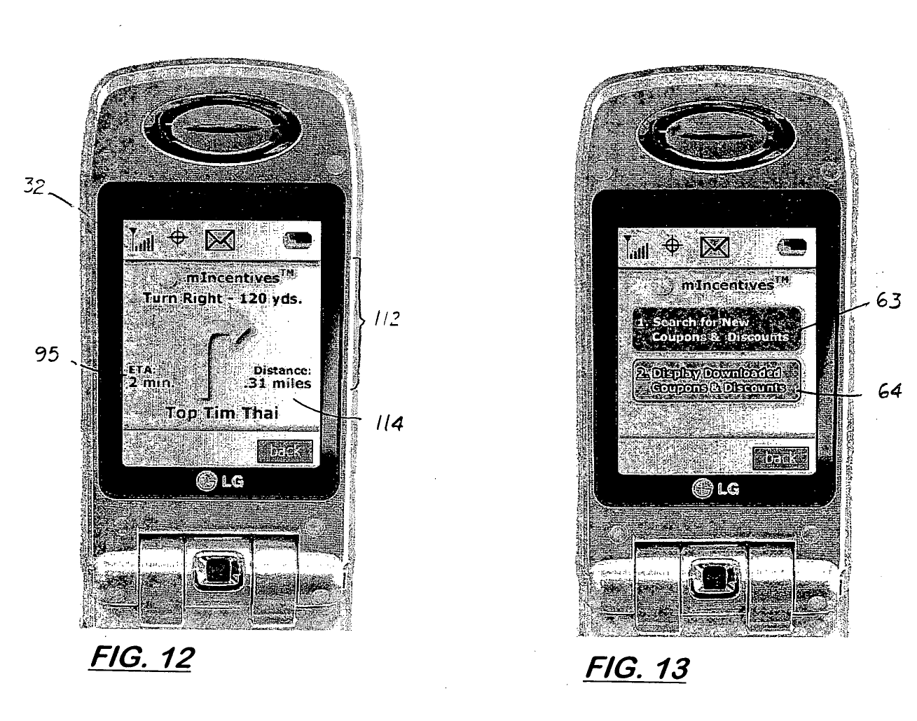

FIG. 12 is an illustration of the display 32 providing specific driving instructions 102, current ETA information 95, and distance information 114 to the business.

FIG. 13 is an illustration identical to the illustration shown in FIG. 2, showing the ‘Display Downloaded Coupons & Discounts button 64. If the customer wants to search for new coupons or discounts after previously downloading a coupon file, he or she selects the ‘Search for New Coupons and Discounts’ button 63 as described above. When this button 63 is selected, the entire search and selection process described above is repeated.

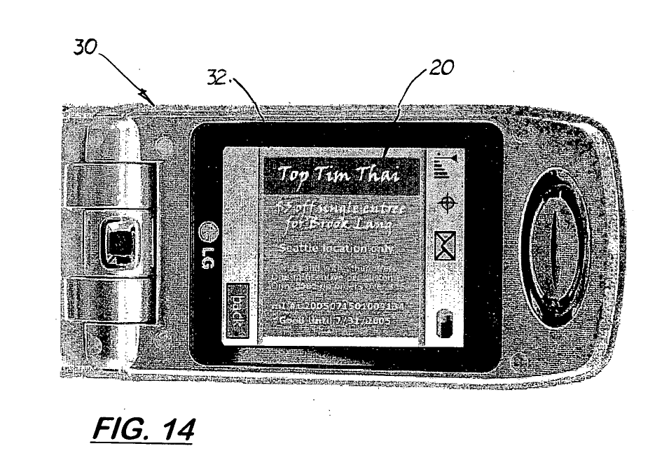

When the customer 11 arrives at the business 13, and wants to use redeem the coupon, he or she then selects the ‘Display Downloaded Coupon & Discount’ button 64 which then displays the coupon 20 shown in FIG. 14. The customer then shows the coupon 20 to the business representative.

An important aspect of the system 10 is that the desired search region 16 for businesses offering coupons must be known by the central server 42. In the preferred embodiment, the system 10 is setup in a default mode so that current location of the wireless communication device 30 is automatically known by the central server 42 that is used to establish the location reference point. A default search radius (1-5 miles) is also used, but may be changed by manual input by the user.

As mentioned above, the precise location of the wireless communication device 30 may be determine by the potential customer's current address, zip code, or cross street location at the time of the request or the address, zip code or cross-street location of the potential customer at a future date or time. The potential customer's location reference point may be automatically determined by the system 10 or manually inputted by the potential customer 11 when the request 14 is submitted to the central server 42. Alternatively, the potential customer's location reference point may be determined by location information provided by the wireless telephone carrier 60 using GPS enabled telephone technology or cellular tower triangulation technology and or with assisted GPS.

In response to a request 14, the central server 42 identifies the potential customer's location reference point, identifies the desired goods and services criteria, and then creates a list or map showing the business names located in the selected vicinity of the potential customer's location reference point. Accompanying each business name is the coupon parameter information that informs the potential customer of the coupon offer. As shown in FIGS. 8-11, such information may include the percent of discount, the expiration date and time, or other conditions or limitations that may apply. Associated with each business listing may be optional business information which may include the address, telephone number and a mileage or distance indicator from the potential customer's current location reference point. An optional map may be requested by the potential customer 11 and generated by the central server 42 and transmitted to the potential customer showing the relative locations the selected businesses found in the search.

The electronic coupon 20 may be any graphic file, (e.g. PDF, JPEG, TIFF, BIP, etc.). In the preferred embodiment the coupon file 21 is a compressed file so that it may be downloaded quickly and uses little memory. When the coupon from a business is selected, the central server 42 may transmit the compress graphic file 21 to the wireless device 30 immediately or at a later designated time. In the preferred embodiment, the file is stored in a compressed format and later simultaneously opened and activated by the customer just prior to redeeming the coupon.

An important benefit of the above described system 10 is that local businesses can easy sign up for the system and begin distributing discount coupons quickly and easily. The graphic file 21 for the coupon 20 may be produced by the system representative or by the business representative. Also, the system 10 may be easily discontinued for changing business conditions. When businesses register with a system representative, a business file is created in the business database 43 containing the pertinent business information, the types of goods and services offered, and business location and contact information. The graphic coupon file 21 is typically stored in the coupon database 44. The business may be given access to their files in the business and coupon database 44 to facilitate changes thereto. Also, monthly reports or statements 120 can be provided to each business informing the business of the number of potential customers 11 that search for a business' goods or services, the number coupons transmitted, the times of day that coupons were requested and transmitted.

Potential customers 11 who use the system may ‘opt-in’ or ‘opt-out’ to provide personal profile information that can be shared with other businesses linked to the system. In exchange for release of this personal information, the potential customer may be offered additional coupons or greater coupon discounts. Also, since the telephone number or network address of the wireless device may be known, the customers may ‘opt-in’ or ‘opt-out’ to receive additional advertisements or notification messages may be transmitted to the potential customer. Also, customers may ‘opt-in’ or ‘opt-out’ to receive notification of new coupon offerings for the same goods or service from the same business in the future or from other competing businesses.

Another benefit is that system 10 is that it may offer priority listing to businesses that offer greater discounts or agree to pay a service charge on the business may other business to use the for reduce costs or greater coupon discounts.

Another benefit is that one the telephone number or network address of the wireless device 30 is known, additional advertisements or notification messages may be transmitted to the potential customer 11.

Another benefit of the system 10 is that once a potential customer 11 is signed up to receive coupons, he or she may ‘opt-in’ to receive notification of new coupon offerings for the same goods or service from the same business in the future or from other competing businesses.

To further describe the system, the following example is provided

### EXAMPLE

A potential customer 11 who is signed up for the above service is interested in going to a nearby restaurant for lunch. The customer opens his or her cellular telephone and presses the services menu button or key on the main menu. After the service application software has been activated, a series of linked menus discussed above are then sequentially presented. Eventually, the potential customer ‘dining’ category, and then selects ‘Thai’.

Next, the potential customer 11 selects the desired search area size in which the service is to search (See menu page in FIG. 5). The type of method used, depends on the location-based service (LBS) available. Such LBS may include cell tower triangulation or GPS based location service supplied by the wireless service that uses the potential customer's telephone. If the potential customer had been accessing the service with a non-enabled located based wireless telephone or from a desktop computer, then the potential customer's zip code may be entered.

After the search radius is determined, general information menu page is displayed showing the list of businesses, and the nature of the coupon offer, and the relative distance from the potential customers' located reference point. The potential customer 11 reviews the lists and selects the business entry offering the best coupon offer. The customer 11 may take into consideration the businesses location and traffic conditions and ETA's to the business.

When a coupon offer is selected, a coupon offer screen is presented that indicates that the coupon is only good for a specific number of days and once activated, for a specific number of hours once activated. As discussed above, the coupon may be downloaded onto the wireless device 20 and activated immediately or it may be downloaded to the wireless device and temporarily stored in a temporary file on the wireless device and activated at a later date and time. Also, as discussed above, because the central server 42 records the customer's name, assigns a coupon serial number, records the date and time the coupon was downloaded, checks to see if the customer has downloaded the coupon before and, if so, when. If the customer is identified and the number of downloads or the time periods have expired, the downloading request is denied. In this example, this is the first request by the customer. The central server 42 transmits the compressed coupon image file 21 to the customer's wireless device 30. The full coupon 20 is date and time stamped for Jul. 31, 2005 only, and limited to a 4 hour period. The coupon offer is only offered once to a customer and cannot be downloaded again within the next thirty days. The coupon file 21 is downloaded in an ‘inactive’ status and is automatically ‘activated’ when the ‘Review, display and Use’ button 125 shown in FIG. 10 is pressed.

Each business listed may include the business' telephone number. In addition, a linked feature may be provided which, when selected, automatically dials the business' telephone number so that the potential customer may call the business to make reservations or pre order food. Also, an option driving instruction feature button and traffic/ETA information buttons and their associated menu pages may be provided that provide turn-by turn driving instructions and current traffic conditions or ETA information to the business based on the potential customer's current location reference point.

In this example, the potential customer 11 selects a nearby business offering a 10% off discount coupon for Thai food dining. Upon arrival, the customer activates the coupon that then displays the coupon on the wireless device's display shown in FIG. 14. When the customer orders the food, he or she shows the coupon 20 to the cashier who verifies that the coupon is valid. The cashier then deducts the amount of the discount from the customer's bill.

With the basic system described above, the following optional features may be used:
1. The system may include a notification feature that notifies the customer of any new coupon offers from businesses in a designated area. The customer can choose the type of notification methods used on the wireless device. (i.e. a ring, a beeping sound, or email);
2. Coupons may be immediately or intermittently ‘pushed’ to the potential customer's wireless device according to specific parameters setup by the potential customer. During the setup process, the potential customer for example, may instruct the central server to automatically send coupons for specific types of food categories, or all coupons offered by businesses in a specific location or during a specific time period;
3. By the potential customer logging into a web site they can conduct a search on the system and have any selected coupons pushed/delivered to their phone;
4. Sharing customer information/profile option in which customers agree submit personal profile information that may be shared with businesses that offers coupons in return for the customer profile information of may offer a greater discount for the customers that offer share the profile information. A person sees a display of an offer from a business but to see all the details of the offer and or to download the coupon the person must authorize that their user profile, demographic info be sent to the Business. The demographic info could also come from another linked database about the user/with the users' profile. Also in the system is a setting that allows the potential customers to set their profile to always be shared with the businesses and or just when it is required by the business.
   a. Sharing potential customer information option in which customers agree to submit personal profile information that may be shared with businesses that offer coupons in return for greater discounted coupons or only discounts to potential customers that share their profile with.
   b. Create a coupon/personal information exchange service in which a person is presented with a limited information about a discount coupon from a business but to see all the details of the discount coupon or to download a valid coupon, the potential customer must share their personal information with the business permission;
5. When a potential customer downloads a coupon that they are opting in to sharing their profile with the business, then the system will e mail and or SMS and or MMS, or web services, EDI, XML feed the customer profile info in some way to the business with a serial number, the transaction number, and the coupon umber for that user's specific coupon. The systems will also send/download the mobile coupon to wireless device/the potential customer downloads the coupon with the same transaction number/serial number coupon in the mobile coupon to store on the mobile device. There are several reasons to do this:
   a. This would server as a higher level of confirming the coupon in the business owner could have the employees write down the serial number of each visual coupon and the then later the business owner could match up the profile info with each cash register discount the employees deducted. Or since the coupon serial number/transaction number could be delivered in real-time the business could match the information sent to the business in some form with the user using the coupon as the discount coupon is used to further validate.
   b. This could also serve as a first come first serve with restaurant table reservations as the info profile sent to the business could have an ETA time in the profile via how far away the potential customer are, and also have a first come, first serve list.
6 The system may be easily modified to keep track of the type of coupons and categories the potential customer has searched in and for, viewed, and downloaded in the past and create “User Experience profile” based thereon together with the necessary algorithms that are weighed heavier on coupons that have been downloaded as apposed to just searching. An additional “Suggested Coupons Button” feature could be included on the wireless device for potential customers to activate. This feature would be populated automatically by the system and not the potential customer (this is not to be confused with a favorite's button where the potential customer sets the parameters for the favorites button).
7. The system could be modified whereby a potential customer could hit one button to review a group of coupons and instead of going through the category search just the most desirable coupon offers. The system administrator or a group of administrators would determine what coupon offer. Also, business would have an opportunity to pay fees for a greater number of downloads;
8. The system could include a ‘Favorites Button’ button feature that allows the customer to sets the parameters for what is most desirable coupons to populate in the favorites button feature through a menu of questions about what coupons they most likely want to see in this section;
9. The system could include a ‘most downloaded coupons’ button that displays the most downloaded coupons from all the potential customers and may be segregated by Category and sub category for the selected region and then the potential customer can review these most popular coupons;
10. ‘Search by Business Name’ This would be for a search by business name of the offers in a defined area.
11. ‘Search by key word in the offers button’. This would be for a search by key words in the text of the offers and or other data provided to the system by the business in the defined area.
12. The system could include an “Instant LBS coupon” button advertising to a selected geographic area (and the ability for the system to put a distance limit on the business to send the instance coupon to—also for how many times a business can send an instant coupon in a month) this works for an end-user that opts-in to receive “instant area coupons” (the potential customer could choose to receive all instant coupons or only in some categories—and or certain times of the day and or days). The business owner can set that a certain area radius (say 1000 feet) and the coupon is valid for say the next 4 hours (the business sets these parameters)—this means for the next 4 hours anyone who comes into this radius of 1000 feet will receive the notice that the coupon is available and then the coupon is auto downloaded to the coupon memory storage area. This is for potential customers that opt in to the “receive instant LBS coupons” feature and the system may let the customer narrow the field of receivable coupons by asking a menu of questions
13. A “comments” system like Internet auction sites where end-users can give comments back about the business and the coupon/offer and potential customers can then see these remarks.
14. The system will allow for a more prevalent stand out of a business coupon. This could be where a business pays more to have their coupon in bold or higher up on the list or a bigger icon or maybe takes up two regular business spaces.
15. Possibly there may be server systems that are located in different locations. If in that case each of these server banks will connect in some way and batch or in real-time communicate with the main worldwide server bank. This will allow reporting information back to the main server banks which in turn the main server banks will be able to generate the e mail reports or a authorized person could log onto the server banks to see, download, and analyze many aggregate reports like:
   a. Below for each server bank and or also in aggregate world wide on the main server banks: (i) Total number of clicks from the mobile desk top and (ii) Total number of clicks from the wired desktop (The rest of the reports can be generated for both or separate for mobile and wired stats for the reports: (iii) Total number of category clicks; (iv) Total number of clicks by each specific category; and, (vi) Total # of sub category level 2 clicks—and so on to the last sub-category level numbers; (vi) Total number of views of offers (also be each category/sub category of views of offers); (vii) Total number of coupons delivered (also by each specific category and sub category of delivered coupons); (viii) Be able to do all of the above reports by geographic location i.e. by zip code, trace out on a map, and plot little pin mark dots on a map to see where people were located when they clicked on—where using the application. Wired users would be in a table beside the map. (ix) Separate out the above and display by time of day the users are using the application at the highest-level report down to the most defined report. Make items different colors or something that designate time of day or just show the numbers via time of day in spreadsheets.
16. The ability in the system to charge the potential customer for using the said wireless coupon system or parts of the wireless coupon system/certain coupons designated as “Charge for use coupons”. An example might be that may of the coupons are free to download but not the ones that an end-user must pay to get them such as the coupons that may come from a relation with the Entertainment Book. Also the ability to charge for individual single coupons. And the ability that any of these charges could be billed in may ways i.e. like to a credit card on file, invoice, or auto billed to the users mobile phone bill and possibly spread out monthly for a year subscription.
17. The system can send an email to the business every time (if the business wants) an end-user clicks on the delivery of the coupon and how far away they are. This way the business owner can get an idea how many people are coming and the e mail gives the business an ETA how far away the potential customer is and if the potential customer were to come right away. As part of this system, the potential customer could be provided a ‘On your way their button’ the potential customer activates to inform the business that the potential customer is on route to the business. And if the potential customer opt-in to share his or her profile information, the business would have the customer's name and can hold a table for them under that name based on the ETA given by the system.
18. A feature by which all the business in the area or in the area of a specific category or sub-category are included in the data base but displayed in some different way so as to show them as separate from businesses offering Coupons.
19. A feature by which the coupon can be electronically transferred and or even validated either by wired or wireless connection to a system in the retailers' transaction system environment in order to apply the offer/coupon value to the users' transaction automatically and electronically. This could be a physical or on-line retailer that uses this system.
20. On a mobile wireless device a person is working in an application and or playing a game and as part of the application or game the system is integrated with the Coupon technology. Example is someone has a private labeled wireless game developed for wireless mobile devices about running a restaurant and put the ABC Restaurant name on it. And so a person downloads the game and is playing it and as part of playing the game or just downloading it or something integrated in the game it—it ask the person if they want to see where the closest ABC restaurant is and the latest coupon. This feature would only show one business location and/or with discount coupons not all the businesses with discounts and not all businesses in the area.
21. A feature where by a potential customer could sent the coupon to another person (but it potentially uses the person sending the coupon as a downloaded coupon issued to the sender, and thus restricted to the originally dates and expiration periods);
22. Feature by where their is the auto determine the point of origin or it is not available or the person wants to set a different point of origin from where they currently are the person can enter zip code, city, state, address, cross street, and or look at a map and move the curser or something around to mark a spot on the map and then the server marks that spot as the point of origin for the end-user.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A method for wireless electronic coupon distribution, comprising the following steps:
a. selecting a wireless communication device capable of connecting to a wireless communication network;
b. contacting to a central server directly or indirectly connected to wireless communication network used by said wireless communication device, said central server being connected to a business database containing the names and locations of businesses offering discounted coupons for goods or services to its potential customers, and to a business coupon database containing discount coupon information of said businesses in said business database, said central server also being connected to a search engine capable of receiving requests from said wireless devices for businesses located in a specified area range that offer discount coupons to its potential customers for a specific good or service, said central server capable of transmitting said search result to wireless communication device;
c. transmitting a request to said central server for at least one businesses offering a discount coupon for a specified good or service in a specified area range;
d. conducting a search by said search engine of said business database for a business offering discount coupons for a specified good or service and located in a specified area range; and,
e. transmitting said search results to said wireless communication device.

2. The method as recited in claim 1, wherein said search result is presented in a list that is transmitted to said wireless communication device.

3. The method as recited in claim 2, wherein said search results are presented in a map showing the location of said business offering a discount coupon.

4. The method as recited in claim 1, furthering including the step (f) of requesting a copy of said discount coupon to be delivered to said wireless device.

5. The method as recited in claim 4, wherein said step (f) is date or time stamped by said central server.

6. The method as recited in claim 5, wherein said discount coupon delivered to said wireless device must be activated before being used.

7. A system of distributing discount coupons to potential customers of a business, comprising:
a. a wireless communication device including a display and input keys;
b. a wireless communication network capable of being used by said wireless communication device;
c. a central server capable of selectively communicating with said wireless communication device when connected to said wireless communication network, said central service capable of transmitting search result information and business coupon information to said wireless communication device;
d. a business database connected to said central server, said business database containing the names and addresses of a plurality of businesses located in the region served by said wireless communication network;
e. a business coupon database containing the discount coupon information of said businesses in said business database, said discount coupon information includes the specific type of goods and services a discount is provided to potential customers, and the amount of the discount; and,
f. a search engine connected to said central server, said search engine capable of receiving requests from said central server for a coupon discount information offered by businesses in said business databank to its potential customers, searching the types of goods and services categories and located in a specific location in said region.

8. The system, as recited in claim 7, wherein said central server transmits said search results to said wireless communication.

9. The system, as recited in claim 8, wherein said central server receives a request for said discount coupon information for a specific business listed on said search results.

10. The system, as recited in claim 7, wherein said central server records the telephone number of said wireless communication device requesting a search for businesses offering specific goods or services in said region.

11. The system, as recited in claim 8, wherein said central server records the telephone number of said wireless communication device requesting a search for businesses offering specific goods or services in said region.

12. The system, as recited in claim 8, wherein said central server time and dates dates records the telephone number of said wireless communication device that receives said search results.

13. The system, as recited in claim 9, wherein said central server time and dates records the telephone number of said wireless communication device that receives said search results.

14. The system, as recited in claim 7, wherein said business coupon information is a graphic file transmitted to said wireless communication device.

15. The system, as recited in claim 14, wherein said graphic file of said business discount coupon is valid for a predetermined date or time period.

16. The system, as recited in claim 11, wherein said graphic file of said business discount coupon is must be ‘activated’ on said wireless communication device before being displayed on said wireless communication device.

17. The system, as recited in claim 16, wherein said graphic file of said business discount coupon when activated is valid for a predetermined date or time period.

18. A method for distributing discount coupons to potential customers of a business, comprising:
a. using a wireless communication device to connect to a remote central server to request the name of at least one business offering an electronic discount coupon for a specific good or service in designated area;
b. searching a database containing the names of businesses that offer electronic coupons for the desired goods or services in the designated area and transmitting the information to said wireless communication device;
c. reviewing the search results for said electronic discount coupon;
d. selecting at leas on electronic discount;
e. transmitting a graphic file of said electronic discount, said graphic file capable being presented on said display on said a wireless communication device; and,
f. presenting said graphic file on said display to said business to redeem said offer.

19. The method as recited in claim 18, wherein said location of said wireless communication device is transmitted to said central server and used to determine the list of businesses offering discount coupons for goods or services.

20. The method as recited in claim 19, wherein said a list of businesses offering discount coupons is transmitted to said wireless communication device, said list includes comparative information regarding the amount of discounts offered on said discount coupons.
